(19) United States
(12) Patent Application Publication
(10) Pub. No.: US 2006/0042518 A1
(43) Pub. Date: Mar. 2, 2006

(54) Methods of reducing hydroxyl ions in concrete pore solutions

(76) Inventors: Paul W. Brown, State College, PA (US); Wendy E. Brown, State College, PA (US)

Correspondence Address: Tara L. Pfaeffle;Eckert Seamans Cherin & Mellott LLC, 44th Floor, 600 Grant Street, Pittsburgh, PA, 15219, US

(21) Appl. No.: 10/972,518

(22) Filed: Oct. 25, 2004

Related U.S. Application Data
(63) Continuation-in-part of application No. 10/927,733, filed on Aug. 27, 2004.

(51) Int. Cl. C04B 28/04

(52) U.S. Cl. 106/713

(57) ABSTRACT

Methods of reducing hydroxyl ions in concrete pore solutions are provided. Such methods are useful in providing resistance to gels which form in concrete due to the alkali-silica (ASR) reaction. The methods comprise, in one aspect, adding a salt to the concrete, in aqueous or solid form, the salt having a cation higher in valence than the anion. In other aspects, the methods of the present invention comprise adding an acidic phosphate or a silicon-containing alkoxide to the concrete. All of the above methods are useful in reducing hydroxyl ions in concrete. Such methods can be used to resist ASR in fresh concrete, in concrete that is setting, or in hardened concrete.

### CROSS-REFERENCE TO RELATED APPLICATIONS

This application is a continuation-in-part of U.S. patent application Ser. No. 10/927,733, filed Aug. 27, 2004, the contents of which are incorporated herein by reference.

### FIELD OF THE INVENTION

The present invention relates to methods of reducing hydroxyl ions in concrete pore solutions by the addition of inorganic or organic acids or salts such as Ca(NO₂)₂, Ca O₃)₂ or calcium acetate.

### BACKGROUND INFORMATION

Concrete is a conglomerate of aggregate (such as gravel, sand, and/or crushed stone), water, and hydraulic cement (such as portland cement), as well as other components and/or additives. Concrete is initially fluid-like when it is first made, enabling it to be poured or placed into shapes. After hardening this property is lost. When concrete is mixed, it takes about twenty-eight percent of the weight of cement as water to fully consume all the cement in making hydration products. However, it is not possible to attain a fluid mix with such a small amount of water, and more water than is needed is added. The additional water simply resides in the pores present in concrete, and is referred to as the pore liquid or pore solution.

When Portland cement is mixed with water to produce concrete, the alkali oxides present in the cement, Na₂O and K₂O, dissolve. Alkali materials are supplied by the cement, aggregate, additives, and even from the environment in which the hardened concrete exists (such as salts placed on concrete to melt ice). Thus, the pore solution produced becomes highly basic. It is not unusual for this pore solution to attain a pH or 13.3 or higher. Depending on the aggregate used in the concrete, a highly basic pore solution may interact chemically with the aggregate. In particular, some sources of silica in aggregate react with the pore solution. This process is called the alkali-silica reaction (ASR) and may result in formation of a gelatinous substance which may swell and cause damage to the concrete. The swelling can exert pressures greater than the tensile strength of the concrete and cause the concrete to swell and crack. The ASR reaction takes place over a period of months or years.

Although the reaction is referred to as the alkali-silica reaction, it will be appreciated that it is the hydroxyl ions that are essential for this reaction to occur. For example, ASR will not occur if silica-containing aggregates are placed in contact with alkali nitrate solutions with Na or K concentrations comparable to those which result in ASR if those solutions were alkali hydroxides.

In extreme cases, ASR can cause the failure of concrete structures. More commonly, ASR weakens the ability of concrete to withstand other forms of attack. For example, concrete that is cracked due to this process can permit a greater degree of saturation and is therefore much more susceptible to damage as a result of “freeze-thaw” cycles. Similarly, cracks in the surfaces of steel reinforced concrete can compromise the ability of the concrete to keep out salts when subjected to deicers, thus allowing corrosion of the steel it was designed to protect.

There are a number of strategies which have been used to mitigate or eliminate ASR. One strategy is to reduce the alkali content of the cement. It is common in cement technology to sum the amounts of K₂O and Na₂O present and express these as an Na₂O equivalent. Cements containing less than 0.6 wt % Na₂O equivalent are called low alkali. However, merely using a low alkali cement does not ensure that the alkali silica reaction can be avoided. Another common strategy is the intentional addition of a source of reactive silica, which acts as an acid to neutralize the alkali. Such sources are fine powders and are typically silica fume (a high surface area SiO₂ formed as a by-product of making ferro-silicon), fly ash (high surface area materials produced in the combustion of coal which contains SiO₂), and natural pozzolans (high surface area materials produced which contains SiO₂ and which are typically produced by volcanic action).

Another technology involves the addition of a soluble source of lithium such as LiOH or LiNO₃. The mechanism of action of Li is not entirely resolved, but it appears to stabilize the alkali silica gels which form. These Li-containing gels then appear to provide a low permeability layer over the underlying reactive material.

There are economic and other disadvantages with most of the above methods. For example, lithium compounds are very expensive and have therefore not gained much acceptance.

The use of mineral admixtures such as silica fume or fly ash requires additional storage silos, and requires additional mixing. Further, silica fume is expensive, and if not properly blended into the concrete can actually cause ASR. Finally, combustion technology is changing to reduce NOₓ emissions, which in turn makes fly ash less reactive and thus less suitable as an additive to reduce ASR. Fly ash and silica fume are not suitable for treatment of existing structures. There remains a need for economic and effective methods of reducing ASR in concrete.

### SUMMARY OF THE INVENTION

The present invention solves the above needs, by providing methods of reducing hydroxyl ions in concrete. In one aspect, the present invention provides a method of reducing hydroxyl ions in concrete pore solutions containing alkali metal cations and hydroxyl ions, comprising adding a salt to the concrete. The salt comprises a cation, denoted herein as Cat, and an anion, denoted herein as An, the cation having a higher valence than the anion. Additionally, the Cat-An salt should have a solubility in water that is greater than Cat-OH, such that when the Cat-An salt dissociates and the Cat precipitates as Cat-OH, the resulting alkali metal-An salt formed remains in solution or has a solubility in the concrete pore solution greater than that of said Cat-An salt.

In another aspect, the present invention provides a method of reducing hydroxyl ions in concrete pore solutions containing alkali metal cations and hydroxyl ions, comprising adding a salt to said concrete, wherein said salt comprises a cation and an anion, said cation having a higher valence than said anion. In this embodiment, the Cat-An salt will have a solubility in concrete pore solutions having pH values higher than that of a saturated Ca(OH)₂ solution in water that is greater than Cat-OH, such that when said Cat-An salt precipitates as Cat-OH the resulting alkali metal-An salt formed remains in solution or has a solubility in water greater than that of said Cat-An salt. This embodiment embraces those anions such as oxalate which are less soluble than Cat-OH in water, but which become more soluble than Cat-OH when the pH of the solution reaches about 13.

In an additional aspect, the present invention provides a method of reducing hydroxyl ions in concrete pore solutions, comprising adding an acidic phosphate to the concrete.

In yet a further aspect, the present invention provides a method of reducing hydroxyl ions in concrete pore solutions, comprising adding a silicon-containing alkoxide to the concrete. The silicon-containing alkoxide has the formula (RO)ₓSiR′₍₄₋ₓ₎, where x can be 1 to 4, R is an alkyl, alkenyl or alkynl group of one or more carbons, straight or branched, and each R can be the same or different from each other R or R′.

In all of the above methods, hydroxyl ions are substantially reduced in the pore solution. While the alkali-silica reaction has been recognized for decades, it was generally not thought to be a problem of excess hydroxyl ions in the pore solution, and remediation efforts did not focus on this aspect. Additionally, the addition of acids to concrete was thought to have a detrimental effect on the desired properties of the concrete. See, e.g., Lea, The Chemistry of Cement and Concrete, pp. 659-676 (Ch 20), which describes the actions of various compounds on concrete, including ammonium acetate, aluminate nitrate, lactic acid, acetic acid, tartaric acid, citric acid and malic acid. All of these are stated to cause attack on the concrete. Oxalic acid exhibits only a minor effect due to the low solubility of Ca oxalate.

It is an object of the present invention, therefore, to provide methods of reducing hydroxyl ions in concrete.

It is an additional object of the present invention to provide a method of reducing hydroxyl ions in concrete by the addition of a salt, an acidic phosphate, or a silicon-containing alkoxide.

These and other aspects of the present invention will become more readily apparent from the following detailed description and appended claims.

### DETAILED DESCRIPTION OF PREFERRED EMBODIMENTS

In one aspect, the present invention provides a method of reducing hydroxyl ions in concrete pore solutions containing alkali metal cations and hydroxyl ions, comprising adding a salt to said concrete. The salt comprises a cation, denoted herein as Cat, and an anion, denoted herein as An, the cation having a higher valence than the anion. Additionally, the Cat-An salt should have a solubility in water that is greater than Cat-OH, such that when the Cat-An salt dissociates, the Cat-OH precipitates, and the resulting alkali metal-An salt formed remains in solution or has a solubility in the concrete pore solution greater than that of said Cat-An salt.

In another embodiment, the present invention provides a method of reducing hydroxyl ions in concrete pore solutions containing alkali metal cations and hydroxyl ions, comprising adding a salt to said concrete, wherein said salt comprises a cation, denoted herein as Cat, and an anion, denoted herein as An, said cation having a higher valence than said anion. In this embodiment, the Cat-An salt will have a solubility in concrete pore solutions having pH values higher than that of a saturated Cat(OH)₂ solution in water that is greater than Cat-OH, such that when said Cat-An salt precipitates as Cat-OH the resulting alkali metal-An salt formed remains in solution or has a solubility in water greater than that of said Cat-An salt. This embodiment embraces those anions, such as oxalate described below, which are less soluble than Cat-OH in water, but which become more soluble than Cat-OH when the pH of the solution reaches about 13.

Any salt containing a suitable cation can be used, so long as the cation has a valence higher than that of the anion and the salt meets the above listed criteria. Suitable cations include, but are not limited to, Ca, Fe, Mg, Mn, Al, Cu, Zn, Sr, Ti and combinations of these. Preferred cations are Ca, Mg, Fe and Al. The most preferred cation is Ca.

Similarly, any salt with a suitable anion can be used, provided that the valence and solubility criteria described above are met. Additionally, the anion must be innocuous in concrete, and should not affect the desirable qualities of concrete such as hardening and durability, and should not subject the reinforcing steel elements in concrete to attack. Thus, certain anions such as chlorides, sulfates and carbonates would not be suitable for use in concrete. Suitable anions can be either organic and inorganic anions, including, but not limited to, nitrate, nitrite, acetate, benzoate, butyrate, citrate, formate, fumarate, gluconate, glycerophosphate, isobutyrate, lactate, maleate, methylbutyrate, oxalate, propionate, quinate, salicylate, valerate, chromate, tungstate, ferrocyanide, pennanganate, monocalcium phosphate monohydrate (Ca(HPO₄)₂.H₂O), hypophosphate, and combinations thereof. Preferred anions include nitrate, nitrite, acetate and oxalate. This list is not meant to be exhaustive, and organic anions that are polymers, such as ionomers and polyelectrolytes, and/or oligomers can be used, provided that they meet the criteria described above. Examples of suitable salts are found in Tables 1, 2 and 3.

As will be appreciated by one skilled in the art, the salt can be added to fresh concrete, in solid or aqueous form, or can be introduced into hardened concrete as an aqueous solution. The salt can also be used to remediate existing concrete by means of an overlay, and can be added to the fresh overlay or the hardened overlay as desired. As used herein, the term “added”, as in “added to concrete”, means the addition of the hydroxyl-removing material to fresh concrete in solid or aqueous form, as well as the introduction of the material into hardened concrete, typically in aqueous form. Methods of mixing the components used to make concrete are standard and well known in the art

As described more fully below in the examples, the amount of salt added will be that amount sufficient to bring the effective Na₂O equivalent to an amount which is less than the effective Na₂O equivalent in the cement used in the concrete, more preferably to an amount which is sufficient to bring the effective Na₂O equivalent to less than about 0.8% by weight of the cement in the concrete, most preferably to less than about 0.6% by weight of cement in said concrete.

Using calcium nitrate as an example, the following reaction will occur:
Ca(NO₃)₂.xH₂O_{(s or aq)}+2AOH_{(aq)}→Ca(OH)₂₍ₛ₎+2ANO_{3(aq)}.
This reaction consumes hydroxyls and, provided that the salt is added in sufficient quantity, it limits the OH concentration to that provided by the calcium hydroxide. Note that even if the salt is added in great excess, the OH concentration will remain nominally the same, namely that of calcium hydroxide.

There is a specific advantage to an organic salt that has molar solubility close to that of calcium hydroxide. Additions of salts to the mixing water may cause acceleration of the rate of setting. This is undesirable when concrete is placed in warm weather. If the common ion effect of calcium on some of the organic salts is considered, their dissolution will be retarded by elevated calcium ion concentrations in solution. Thus, during the early hydration, the calcium entering solution as a result of cement hydration will inhibit the dissolution organic Ca salts. However, as the Ca drops in response to Na and K entering solution, through the common ion effect of hydroxyl on the solubility of calcium hydroxide, then the organic salts will dissolve, and in doing so reduce the hydroxyl ion concentration. Using nitrate salts as examples of the reactions of interest are as follows:

(wherein A=Na and/or K)
Al(NO₃)₃.xH₂O_{(s or aq)}+3AOH_{(aq)}→Al(OH)₃₍ₛ₎+3ANO_{3(aq)}
Fe(NO₃)₃.xH₂O_{(s or aq)}+3AOH_{(aq)}→Fe(OH)₃₍ₛ₎+3ANO_{3(aq)}

Alternatively:
Fe(NO₃)₃.xH₂O_{(s or aq)}+3AOH_{(aq)}→FeOOH₍ₛ₎+3ANO_{3(aq)}
Fe(NO₃)₂.xH₂O_{(s or aq)}+2AOH_{(aq)}→Fe(OH)₂₍ₛ₎+2ANO_{3(aq)}
Ca(NO₂)₂.xH₂O_{(s or aq)}+2AOH_{(aq)}→Ca(OH)₂₍ₛ₎+2ANO_{2(aq)}
Ca(NO₃)₂.xH₂O_{(s or aq)}+2AOH_{(aq)}→Ca(OH)₂₍ₛ₎+2ANO_{3(aq)}
Mg(NO₂)₂.xH₂O_{(s or aq)}+2AOH_{(aq)}→Mg(OH)₂₍ₛ₎+2ANO_{2(aq)}
Mg(NO₃)₂.xH₂O_{(s or aq)}+2AOH_{(aq)}→Mg(OH)₂₍ₛ₎+2ANO_{3(aq)}
Zn(NO₂)₂.xH₂O_{(s or aq)}+2AOH_{(aq)}→Zn(OH)₂₍ₛ₎+2ANO_{2(aq)}
Zn(NO₃)₂.xH₂O_{(s or aq)}+2AOH_{(aq)}→Zn(OH)₂₍ₛ₎+2ANO_{3(aq)}
Sr(NO₂)₂.xH₂O_{(s or aq)}+2AOH_{(aq)}→Sr(OH)₂₍ₛ₎+2ANO_{2(aq)}
Sr(NO₃)₂.xH₂O_{(s or aq)}+2AOH_{(aq)}→Sr(OH)₂₍ₛ₎+2ANO_{3(aq)}
Sn(NO₂)₂.xH₂O_{(s or aq)}+2AOH_{(aq)}→Sn(OH)₂₍ₛ₎+2ANO_{2(aq)}
Sn(NO₃)₂.xH₂O_{(s or aq)}+2AOH_{(aq)}→Sn(OH)₂₍ₛ₎+2ANO_{3(aq)}

The free water produced in these reactions is ignored. x may be 0 for anhydrous nitrates and nitrites or may be various numbers specific to a particular compound. Some nitrates and nitrite compounds may have a number of different hydrates, and in these cases there will be a range of possible values for x.

More generalized versions of the above equations are as follows:
Cat(An)₂.xH₂O_{(s or aq)}+2AOH_{(aq)}→Cat(OH)₂₍ₛ₎+2AAn_{(aq)}
Cat(An)₃.xH₂O_{(s or aq)}+3AOH_{(aq)}→Cat(OH)₃₍ₛ₎+3AAn_{(aq)}
where Cat refers to cation, An refers to anion, and A refers to alkali metal.

The possibility of the formation of a soluble intermediate ASn(OH)₃ is recognized. The above list is exemplary and not meant to be exhaustive, and 4 and 5 valent nitrates and nitrites can also be used:
Eg. Ti(NO₃)₄.xH₂O_{(s or aq)}+4AOH_{(aq)}→TiO₂₍ₛ₎+4ANO_{3(aq)}

In another aspect, the present invention provides a method of reducing hydroxyl ions in concrete pore solutions, comprising adding an acidic phosphate to the concrete. Any suitable acidic phosphate can be used, so long as it has the ability to release a proton in exchange for picking up a Na⁺ or K⁺. Preferably, the acidic phosphate is phosphoric acid, monobasic phosphate, or dibasic phosphate, or combinations of these. The cation of the acidic phosphate can be selected from the group consisting of Na⁺, K⁺, NH₄⁺ and combinations thereof. The acidic phosphate can be added to fresh concrete as a solid or as an aqueous solution, and can also be introduced into hardened concrete. It can also be used in an overlay over existing concrete, as described above. The amount used is as described above for addition of a salt.

The following reaction, by way of example only, illustrates this aspect of the present invention:
E.g. NaH₂PO_{4(s or aq)}+Na⁺+OH⁻→Na₂HPO_{4(s or aq)}+HOH
In this, a buffering reaction, monobasic sodium phosphate is converted to dibasic sodium phosphate. In this conversion a proton is liberated and its reaction with an hydroxylproduces water. This class of reactions differs from those described above because a solid hydroxide is not precipitated.

In The Chemistry of Silica by Iler, (FIG. 1.6, p. 42) the solubility of amorphous silica as a function of pH is shown. Solubility increases by a factor of about 10 or more between pH 9 and pH 11, and continues to increase with further pH elevation. Certain types of aggregate used in concrete contain silicate minerals which show elevated silica solubility at the pH values normally present in concrete pore solutions. The elevated pH values of these solutions are the result of the presence of alkali hydroxides.

It is has been recognized that alkali silicates in liquid form may be added to concrete as a means of pore blocking. For example, potassium silicate solutions may be added to hardened concrete to react with available calcium hydroxide to produce calcium silicate hydrate. However, this would not be an acceptable means for mitigating the effects of ASR because the reactions involved also produce a potassium hydroxide solution.

As described above, basicities of concrete pore solutions can be reduced by the addition of salts comprised of a polyvalent cation and an anion of a strong acid. Another method to achieve a reduction in hydroxyl ion concentration is the direct addition of an appropriate acid species. The direct addition of an acid at the time of mixing of fresh concrete is theoretically possible, provided an appropriate acid could be found. Addition of an acid to hardened concrete is also theoretically possible, provided that such an acid could be found and could be made to intrude the concrete pore structure.

One such acid is silicic acid. It is also accepted that hydrous silica is an acid: SiO₂.2H₂O═H₄SiO₄. Acidic silicates in solid form, including those present in fly ash, in silica fume, and in natural pozzolans, are routinely added to fresh concrete. Thus, a method by which hydrous silica could be added to in-place concrete also has the capability of reducing the alkali-silica reaction. Such a method involves the addition of a silicon-containing alkoxide. Commonly available alkoxides include tetramethyloxysilane (TMOS) (CH₃O)₄Si, tetraethyloxysilane (TEOS) (C₂H₅O)₄Si, and ethyl silicate 40. The latter is a solution of partially hydrolyzed TEOS comprised of oligomers containing on average 5 silicon atoms per oligomer. These alkoxides produce hydrous silica by a combination of hydrolysis and condensation reactions.

Using TEOS as an example, the following hydrolysis reactions occur to produce an amorphous silicate:
(C₂H₅O)₄Si+H₂O→(C₂H₅O)₃SiOH+C₂H₅OH
(C₂H₅O)₃SiOH+H₂O→(C₂H₅O)₂Si(OH)₂+C₂H₅OH
(C₂H₅O)₂Si(OH)₂+H₂O→C₂H₅OSi(OH)₃+C₂H₅OH
C₂H₅OSi(OH)₃+H₂O→Si(OH)₄+C₂H₅OH
More broadly, these equations can be written as:
(RO)₄Si+H₂O→(RO)₃SiOH+ROH.
(RO)₃SiOH+H₂O→(RO)₂Si(OH)₂+ROH
(RO)₂Si(OH)₂+H₂O→ROSi(OH)₃+ROH
ROSi(OH)₃+H₂O→Si(OH)₄+ROH
Each hydrolysis step produces a molecule of ethanol. Simultaneously, condensation reactions, such as the following, occur:
(C₂H₅O)₃SiOH+(C₂H₅O)₃SiOH→(C₂H₅O)₃SiOSi(C₂H₅O)₃+H₂O
or, more broadly, (RO)₃SiOH+(RO)₃SiOH→(RO)₃SiOSi(RO)₃+H₂O

The condensation reactions are polymerization reactions in which a simple molecule is eliminated from the silicate and an oxygen-silicon-oxygen bond is formed.

Thus, in an additional aspect, the present invention provides a method of reducing hydroxyl ions in concrete pore solutions, comprising adding a silicon-containing alkoxide to the concrete. The silicon-containing alkoxide has the formula (RO)ₓSiR′₍₄₋ₓ₎, where x can be 1 to 4, R is an alkyl, alkenyl or alkynl group of one or more carbons, straight or branched, and each R can be the same or different from each other R or R′. Preferred silicon-containing alkoxides are tetramethyloxysilane, tetraethyloxysilane and ethyl silicate 40, a silicon-containing alkoxide that is partially hydrolyzed TEOS to achieve a Si content above 28% by weight, and optimally 40% by weight.

The length of the carbon chain in the alkoxide will be limited by the silicon-containing alkoxide's solubility in water. When the molecule becomes so insoluble (as with longer carbon chains) that it hydrolyzes very slowly or not at all, the compound will be inadequate for controlling the ASR reaction. As will be appreciated, the rate of hydrolysis is also a function of the pH of the solution and the susceptibility of aggregate materials to be attacked. The suitability of a particular silicon-containing alkoxide can be easily determined by one skilled in art without undue experimentation, using empirical methods such as testing the compound in concrete or in pore solutions for its ability to remove hydroxyl ions from the concrete or pore solution.

As with prior embodiments, the silicon-containing alkoxide can be added to fresh concrete, in solid or aqueous form, and introduced into hardened concrete in aqueous form. It can also be added to fresh concrete for use as an overlay over existing concrete, or is introduced into a hardened concrete overlay over existing concrete. The amount used will be an amount sufficient to provide a sufficient number of protons to reduce the effective Na₂O content of the cement in the concrete to less than about 0.8% by weight of cement, more preferably to less than about 0.6% by weight of cement or less. In all of the above methods, the amount used can also be an amount sufficient to bring the effective Na₂O equivalent to an amount which is less than the effective Na₂O equivalent of the cement used in said concrete.

TABLE 1

| | solubility | | molar |
|---|---|---|---|
| Compound | g/100 cc | mol wt | solubility |
| Ca hydroxide | 0.16 | 72 | 0.0223 |
| Ca acetate | 37.4 (0) | 158 | 2.36 |
| Ca benzoate | 2.7 (0) | 336 | 0.08 |
| Ca butyrate | soluble | 268 | |
| Ca citrate | 0.85 (18) | 570 | 0.015 |
| Ca formate | 16.2 (20) | 130 | 1.25 |
| Ca fumarate | 2.11 (30) | 205 | 0.103 |
| Ca d-gluconate | 3.3 (15) | 448 | 0.074 |
| Ca glycerophosphate | 2 (25) | 210 | 0.19 |
| Ca isobutyrate | 20 | 304 | 0.658 |
| Ca lactate | 3.1 (0) | 308 | 0.101 |
| Ca maleate | 2.89 (25) | 172 | 0.168 |
| Ca methylbutryate | 24.24 (0) | 242 | 1.002 |
| Ca propionate | 49 (0) | 204 | 2.402 |
| Ca l-quinate | 16 (18) | 602 | 0.266 |
| Ca salicyate | 4 (25) | 350 | 0.114 |
| Ca valerate | 8.28 (0) | 242 | 0.342 |
| Ca nitrate | 121.2 (18) | 164 | 7.39 |
| Ca chromate | 16.3 (20) | 192 | 0.849 |
| Ca ferrocyanide | 80.8 (25) | 490 | 1.649 |
| Ca permanganate | 331 (14) | 368 | 8.995 |
| Ca MCPM | 1.8 (20) | 252 | 0.071 |
| Ca hypophosphate | 15.4 (25) | 170 | 0.906 |
| Mg(OH)2 | .0009 (18) | 58 | 5.6 × 10⁻¹¹ |
| Mg laurate | .007 (25) | 459 | 1.5 × 10⁻⁴ |
| Mg myristrate | .006 (15) | 479 | 1.3 × 10⁻⁴ |
| Mg oleate | .024 (5) | 587 | 4.1 × 10⁻⁴ |
| Mg oxalate | .07 (16) | 148 | 4.7 × 10⁻³ |
| Mg stearate | .003 (14) | 591 | 5.1 × 10⁻⁵ |

value in parenthesis is the temperature at which the solubility was determined.

TABLE 2

| | | | | sol. | at | Advantages |
|---|---|---|---|---|---|---|
| Compound name | Formula | abbr | mol wt | g/100 cc | ° C. | or Disadvantages |
| aluminum nitrate nonohydrate | Al(NO3)3.9H2O | ANN | 375.13 | 63.7 | 25 | (-) sulfate attack |
| calcium nitrate tetrahydrate | Ca(NO3)2.4H2O | CNT | 236.15 | 266 | 0 | Stability question |
| calcium nitrate anhydrous | Ca(NO3)2 | CN | 164.09 | 121 | 18 | |
| calcium nitrite monohydrate | Ca(NO2)2.H2O | CAN | 150.11 | 45.9 | 0 | (−) expense |
| chromium nitrate | | | | | | (-) toxic |
| ferrous nitrate | | | | | | Stability question |
| ferric nitrate nonohydrate | Fe(NO3)3.9H2O | FNN | 404.2 | sol | | (−) color |
| ferric nitrate hexahydrate | Fe(NO3)3.6H2O | FNH | 348.4 | | | |
| copper nitrate hexahydrate | Cu(NO3)2.6H2O | | 295.64 | 243.7 | 0 | |
| copper nitrate trihydrate | Cu(NO3)2.3H2O | | 241.6 | 137.8 | 0 | |
| copper nitrate 2.5hydrate | Cu(NO3)2.2.5H2O | | | | | |
| magnesium nitrate dihydrate | Mg(NO3)2.2H2O | MND | 184.35 | sol | | (+) expense |
| magnesium nitrate hexahydrate | Mg(NO3)2.6H2O | MNH | 256.41 | 125 | | |
| manganese nitrate tetrahydrate | Mn(NO3)2.4H2O | | 251.01 | 426.4 | 0 | |
| strontium nitrate anhydrous | Sr(NO3)2 | SN | 211.63 | 70.9 | 18 | |
| strontium nitrate tetrahydrate | Sr(NO3)2.4H2O | SNT | 283.69 | 60.43 | 0 | |
| zinc nitrate tetrahydrate | Zn(NO3)2.3H2O | | 243.43 | | | |
| zinc nitrate hexahydrate | Zn(NO3)2.6H2O | | 297.47 | 181.3 | 20 | |

molality = (wt in g of solid) (1/mw)/1000 g of H2O. 10% soln = 100 g solid + 900 g H2O = 111.1 g solid/1000 g soln or 111.1 g of solid per 1000 g of sol'n

TABLE 3

| | 10 wt % | molality | wt | wt | wt % | | Wt NaOH/ | Wt of | pH |
|---|---|---|---|---|---|---|---|---|---|
| | soln, | X moles | solid, | H2O + | solid, | soln | Ca(OH)2 | nitrate soln | after |
| Formula | molality | NO3 | g | Solid | g | pH | soln*, g | added, g | add'n |
| Al(NO3)3.9H2O | 0.296 | 0.888 | 5.02 | 51.79 | 9.69 | 1.85 | 39.51 | 8.67 | 12.34 |
| Ca(NO3)2.4H2O | 0.47 | 0.92 | 5.2 | 52.08 | 9.98 | 5.38 | 41.76 | 13.61 | 12.36 |
| Ca(NO3)2 | 0.677 | 1.334 | | | | | | | |
| Ca(NO2)2.H2O | 0.74 | 1.48 | | | | | | | |
| Fe(NO3)3.9H2O | 0.274 | 0.822 | 5.04 | 54.07 | 9.32 | 0.3 | 39.44 | 11.64 | 12.46 |
| Fe(NO3)3.6H2O | 0.319 | 0.958 | | | | | | | |
| Cu(NO3)2.6H2O | 0.378 | | | | | | | | |
| Cu(NO3)2.3H2O | 0.46 | | 5.07 | 50.98 | 9.93 | | | | |
| Cu(NO3)2.2.5H2O | | | | | | 2.87 | | | |
| Mg(NO3)2.2H2O | 0.602 | 1.204 | | | | | | | |
| Mg(NO3)2.6H2O | 0.433 | 0.866 | 5.08 | 50.07 | 10.14 | 4.91 | 42.78 | 18.03 | 12.56 |
| Mn(NO3)2.4H2O | 0.443 | 0.886 | | | | | | | |
| Sr(NO3)2 | 0.525 | 1.05 | | | | | | | |
| Sr(NO3)2.4H2O | 0.392 | 0.784 | | | | | | | |
| Zn(NO3)2.3H2O | 0.456 | 0.912 | | | | | | | |
| Zn(NO3)2.6H2O | 0.373 | 0.746 | | | | | | | |

*0.3 M NaOH + 10 g Ca(OH)2 + 0.005 M Na2SO4 pH before any additions = 13.02

Accelerating admixtures containing calcium nitrate, calcium nitrite, and calcium formate have been added to fresh concrete to accelerate hydration in cool weather. However, the use of salts as ASR admixtures is distinguishable over the use of salts as accelerating admixtures.

Accelerating admixtures are used in cool weather and are applied to fresh concrete. ASR admixtures, on the other hand, may be used in warm weather and may be applied to concrete that is setting or hardened concrete. “Fresh concrete” refers to the aqueous or slurry-like mixture of water, cement, and aggregate that is mixed together to form new concrete. “Setting concrete” refers to concrete that is changing from a slurry into a solid and has reached or passed through the “set point,” which is the point at which the concrete is no longer in a plastic state. Concrete is considered to be setting once it has reached or passed through the time of initial set. “Setting speed” refers to the rate at which the concrete is setting. “Hardened concrete” refers to concrete that is substantially solidified. The alkali silica reaction may be treated in fresh concrete, concrete that is setting, or hardened concrete.

Accelerating admixtures are typically used at room temperature or below, with a preferred ambient temperature range of about 50° F. or below. W R Grace markets Daracel, a commercial accelerating admixture that contains calcium chloride, and recommends it for use at an ambient temperature of 50° F. and below. (The addition level for Daracel is 8-40 oz per 100 lb of cement.) Rear and Chin, Concrete Intl 12:55-58 (1990) tested non chloride accelerating admixtures at 10 and 22° C. Brook et al, Concrete Intl 12:55-58 (1990) tested non-chloride accelerating admixtures at 10 and 21° C. The ability of calcium formate to accelerate hydration is substantially diminished when the ambient temperature is raised from 70° F. to 100° F. At 70° F. the time of set decreases from about 3.25 hr to 2 hr in going from 0 to 2 percent calcium formate. At 100° F., the time of set decreases from about 1.25 to about 0.75 hr in going from 0 to 2 percent calcium formate. (V. S. Ramachandran: Concrete Admixtures Handbook, 3^{rd} Ed (1995))

When used as ASR admixtures in warm weather, salts may be combined with a retarding admixture such as calcium lignosulfonate or sodium and calcium salts of hydrocarboxylic acids, including salts of gluconic, citric, and tartaric acids. For example, calcium lignosulfonate may be added along with calcium nitrate. Such retarding agents would not be used in conjunction with an accelerating admixture.

When a salt such as calcium nitrate, calcium nitrite, or calcium formate is used as an ASR admixture, it may be mixed with other calcium salts not known to be accelerators, e.g., calcium acetate or calcium hydroxide. This would not be done if the salt is being used as an accelerating admixture. In addition, it is unlikely that calcium acetate would be used as an accelerator.

Another distinction is that the dosages of calcium nitrate, calcium nitrite, or calcium formate, when used as accelerating admixtures, vary depending on the temperature whereas the dosages of calcium nitrate, calcium nitrite, or calcium formate, when used as ASR admixtures, are independent of temperature and substantially depend on Na₂O equivalent in the cement. For a given concrete mix design, the dosages of calcium nitrate, calcium nitrite, or calcium formate, when used as ASR admixtures, will be constant and will depend substantially on the alkali content of the cement, whereas the dosages of calcium nitrate, calcium nitrite or calcium formate, when used as accelerating admixtures, will depend on the temperature and on the desired rate of strength gain.

In the case of ASR admixtures, the addition of calcium nitrate, calcium nitrite, or calcium formate can be delayed anywhere from one day to several years following the mixture of fresh concrete. Even with a delayed addition, these salts will be effective at resisting ASR. However, when calcium nitrate, calcium nitrite, or calcium formate are used as accelerating admixtures, the addition of these compounds cannot be delayed. With a delayed addition, the salts will not be effective at accelerating hydration; the salts' ability to accelerate hydration decreases as the fresh concrete begins to set and harden. Furthermore, calcium nitrate, calcium nitrite, or calcium formate, when used as ASR admixtures, remain effective when introduced to the pore structure of concrete that has already hardened, whereas the introduction of calcium nitrate, calcium nitrite or calcium formate as accelerating admixtures would have no effect on the strength of hardened concrete.

An accelerating admixture is most effective at 1 day, somewhat less effective at 7 days, even less effective at 28 days, and of no importance at 1 year. The timeframe over which the alkali silica reaction occurs is minimally months and most importantly years. Thus, the timeframes during which ASR treatment is relevant do not overlap the timeframes during which acceleration is relevant. According to A. M. Paillere, Ed., Applications of Admixtures in Concrete (1995), calcium formate increases compressive strengths at 28 days, and calcium nitrite increases compressive strength at 1, 3, and 28 days (p. 40); calcium nitrate accelerates setting times (measured in hours) but only moderately accelerates hardening (p. 37).

To delay the release of an ASR admixture, the salt particles may be coated with a dissolving agent such as a polymer. In a particular embodiment, crystals of soluble salts, such as calcium nitrate or calcium nitrite, may be encased by coatings used in the formation of pharmaceutical tablets. Such coatings may include those used in time-release analgesics and would be intended to survive until final set or longer at which point they would dissolve and release the encased salts. The Aveka Group offers commercially available processes for coating particulate materials, including spray drying and prilling, and dry powder coating. The coating solution may contain dissolved polymer, sugar, inorganic salts, sol gels, or other dissolved materials. Methylcellulose or another time release coating may also be used. Delayed release would interfere with acceleration of the concrete, but would have no effect on control of ASR.

Table 4 below (from R. Rixom and N. Mailvagnam: Chemical Admixtures for Concrete, 3rd Ed (1999), p. 183) shows the effects of calcium nitrite on strength development.

TABLE 4
Compressive strength, MPa

| % | | | |
|---|---|---|---|
| admixture | 1 day | 7 days | 28 days |
| 0 | 9.0 | 23.5 | 24.7 |
| 2 | 11.1 | 31.3 | 39.5 |
| 3 | 13.5 | 34.2 | 40.7 |
| 4 | 15.8 | 36.8 | 44.0 |
| 5 | 16.3 | 36.7 | 44.8 |
| | No statistically | No statistically | No statistically |
| | meaningful | meaningful | meaningful |
| | change | Change | change |
| | beyond 3-4% | beyond 3% | beyond 2% |

It appears that the broad range for use of a salt as an accelerator is about 2 to 5 percent, with a preferred range of about 3 percent or below for calcium nitrite and 2 percent or below for calcium formate (V. S. Ramachandran: Concrete Adinixtures Handbook, 3^{rd} Ed (1995)).

This illustrates another difference between the use of salts as accelerators and the use of salts as ASR admixtures. The amount of ASR admixture added to the concrete is directly proportional to the quantity of hydroxyl ions removed from the pore solution. For every mole of an ASR admixture comprised of calcium nitrate, calcium nitrite, or calcium formate added to a given amount of concrete, two moles of hydroxyl ions will be removed as Ca(OH)₂. Thus, the relationship between the amount of ASR admixture and the amount of hydroxyl ions removed from the pore solution may be a straight line.

Another distinction is that calcium nitrite as an accelerator has been combined with calcium rhodonate-triethylamine to achieve acceleration (V. S. Ramachandran: Concrete Admixtures Handbook, 3^{rd} Ed (1995), p. 170). This would not be the case if calcium nitrite was used as an ASR admixture. In addition, use of calcium nitrate in conjunction with triethanolamine as an accelerating admixture was proposed in 1981 (V. Dodson, Concrete Admixtures, 1990, p. 92). Such would not be the case when calcium nitrate is used as an ASR admixture. Moreover, calcium nitrite would not typically be added unless there was a concern for corrosion of embedded steel.

Calcium formate accelerates hydration of tricalcium silicate, but not beyond about 2 percent addition (V. S. Ramachandran: Concrete Admixtures Handbook, 3^{rd} Ed (1995), p. 257). This is also in accord with (V. Dodson, Concrete Admixtures, 1990). Enhancing the reactivity of tricalcium silicate is required to achieve meaningful acceleration. The use of calcium formate as an ASR admixture is not subject to such a limitation. According to A. M. Paillere, Ed., Applications of Admixtures in Concrete (1995), p. 37, a consensus document produced by a RILEM committee populated by experts on chemical admixtures, calcium formate is sometimes blended with other compounds, such as sodium nitrite, to enhance early strength development. This would never be done if calcium formate were used as an ASR admixture.

Rixom and Mailvaganam teach there to be negligible effect on acceleration when an accelerating admixture contains more than 4 percent of calcium nitrite (R. Rixom and N. Mailvagnam: Chemical Admixtures for Concrete, 3^{rd} Ed (1999)). The use of calcium nitrite as an ASR admixture is not subject to such a limitation.

The addition of a low solubility double salt containing calcium cations and monovalent anions may also interfere with ASR. For example, Ca(NO₂)₂.Ca(OH)₂.xH₂O (where x is a whole number ranging from about 0 to 4) may interfere with ASR in proportion to the amount of Ca(NO₂)₂ present in the salt. Because the double salt exhibits a lower solubility than Ca(NO₂)₂ alone, it would exhibit diminished or negligible effect on acceleration by comparison. However, because the times and modes of action between set acceleration and control of ASR differ, this salt would be effective for control of ASR. A double salt of calcium hydroxide or calcium nitrate may also be used.

The addition of a mixture containing from about 40 to 60 percent of nitrate (NO₃) ions and about 60 to 40 percent of nitrite (NO₂) ions may be employed to interfere with ASR. For example, Gaidis (Cem. Concr. Comps. 26: 181-89 (2004)) reported a 50-50 mixture of nitrate (NO₃) and nitrite (NO₂) ions that is produced when NO₂ gas is bubbled into an alkaline aqueous medium. Accordingly, the following reaction would occur if the alkaline medium were a calcium hydroxide solution: 2NO₂+2OH⁻ [which could be supplied by 2Ca(OH)₂]→NO₂⁻ and NO₃⁻ and H₂O. Giving explicit consideration to the presence of calcium, the following reaction would occur: 4NO₂+2Ca(OH)₂→Ca(NO₂)_{2(aq)} and Ca(NO₃)_{2(aq)}+2H₂O. There is no need to subsequently separate the nitrate and nitrite (which is economically advantageous) because they will act in combination as an admixture to control ASR. It does not appear that such a combination has been used either as an accelerator or in the case of calcium nitrite as a corrosion inhibitor.

### EXAMPLES

The following examples are intended to illustrate the invention and should not be construed as limiting the invention in any way.

It is understood in the art that a low alkali cement contains less than about 0.6 wt % of Na₂O equivalent. Na₂O equivalent is the total amount of both Na₂O and K₂O present in the cement, reported as Na₂O equivalents. Recognizing that Na₂O+2H₂O→2NaOH, one can calculate the amount of a salt that is required to reduce the effective Na₂O equivalent to the desired value. The following examples illustrate one embodiment of the present invention, in which there is added sufficient salt to bring the effective Na₂O equivalent to this 0.6% value.

### Example 1

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94 x 0.01=5.17 lb. To bring this value down to an Na₂O equivalent 0.6% requires neutralization of 0.4×5.17=2.07 lb. If the preferred admixture is Ca(NO₃)₂ then on a molar basis, Na₂O+2H₂O+Ca(NO₃)₂→Ca(OH)₂+2NaNO₃. Thus, one mole of Ca(NO₃)₂ would be required for each mole of Na₂O to be neutralized.

Based on the molecular weights per mole, neutralization of 62 g of Na₂O would require 164 g of Ca(NO₃)₂. This ratio is 2.65. Thus, 2.07 lb of Na₂O would require the presence of 5.48 lb of Ca(NO₃)₂ per cubic yard of concrete. If the water-to-cement ratio were 0.5, the concrete would be made by mixing the cement with 5.5×94×0.5=258.5 lb of water per cubic yard. Calcium nitrate can be added to this mixing water as crystals that would readily dissolve.

### Example 2

An alternative method for reducing hydroxyl ions in concrete is to limit the total alkali content in a cubic yard of concrete. The alkali content in a cubic yard of concrete will increase as the cement content of the concrete increases. The if one mix uses 4.5 sack per cubic yard while another uses 7 sack per cubic yard of the same cement. The alkali content of the 7 sack mix will be 7/4.5=1.56 times higher than that of the 4.5 sack mi. xln metric units alkali silica reaction is not considered a problem is the Na₂O equivalent is in the range of 1.8 to 3 kilograms per cubic meter (1.31 cu yard). Assume a typical cement content of 13 weight percent and a typical weight of a cubic meter of concrete to be 2400 kg and a Na₂O equivalent of 1%. Thus the total alkali equivalent will be 2400×0.13×0.01=3.12 kg for the equivalent of a 5.5 sack mix and 4.87 kg for a 7 sack mi. xln the latter instance a reduction of the content to a maximum of 3 kg per cubic meter would require the addition of sufficient Ca(NO₃)₂ to reduce the Na₂O equivalent by 1.87 kg/cubic meter. Again, according to the reaction Na₂O+2H₂O+Ca(NO₃)₂→Ca(OH)₂+2NaNO₃, this would require the addition of 4.95 kg of calcium nitrate.

### Example 3

### Use of an Organic Salt

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. If the preferred admixture is calcium acetate then on a molar basis, Na₂O+2H₂O+Ca(Ac)₂→Ca(OH)₂(Solid)+2NaAc. Thus, one mole of Ca(Ac)₂ would be required for each mole of Na₂O to be neutralized.

Based on the molecular weights per mole, neutralization of 62 g of Na₂O would require 158 g of Ca(NO₃)₂. This weight ratio is 2.55. Thus, 2.07 lb of Na₂O would require the presence of 5.28 lb of Ca(Ac)₂ per cubic yard of concrete. If the water-to-cement ratio were 0.5, the concrete would be made by mixing the cement with 5.5×94×0.5=258.5 lb of water per cubic yard. Calcium acetate can be added to this mixing water as crystals that would readily dissolve.

### Example 4

### Use of a Free Organic Acid

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. If the preferred admixture is oxalic acid then on a molar basis,

Na₂O+2H₂O+HO₂CCO₂H Na₂(COO)₂. Thus, one mole of oxalic acid would be required for each mole of Na₂O to be neutralized.

Based on the molecular weights per mole, neutralization of 62 g of Na₂O would require 90 g of oxalic acid. This weight ratio is 1.45. Thus, 2.07 lb of Na₂O would require the presence of 3 lb of oxalic acid per cubic yard of concrete. If the water-to-cement ratio were 0.5, the concrete would be made by mixing the cement with 5.5×94×0.5=258.5 lb of water per cubic yard. Oxalic acid can be added to this mixing water as crystals. Alternatively, oxalic acid dehydrate crystals could be added provided the proportions were altered to consider the molecular weight difference.

### Example 5

### Use of an Alkoxide

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. TEOS, tetraethyl oxysilane is a liquid at room temperature which has a limited solubility in water. In the proportions needed it will be soluble with the mixing water used to produce concrete. TEOS liquid will be added to the mixing water and will hydrolyze to produce oligomers of approximate composition SiₙO₍₂ₙ₊₁₎H₍ₙ₊₂₎. These will react in turn with Na and hydroxyls to produce Na₂SiO₃.9H₂O. Thus, 1 mole of Na₂O is consumed per mole of TEOS. On a weight ratio basis, 208 g of TEOS are required per 62 g of Na₂O. Thus to neutralize 2.07 lb of Na₂O will require 6.94 lb of TEOS. Given a density of TEOS liquid of about 1.4, this will require about 0.5 liter per cubic yard of concrete.

### Example 6

### Remediation of Existing Concrete

The reaction in concrete presently undergoing ASR can be stopped by allowing solution containing calcium nitrate to soak into the concrete. As this occurs, the reaction 2NaOH+2H₂O+Ca(NO₃)₂→Ca(OH)₂+2NaNO₃ will propagate.

A similar reaction will occur in the event the alkali is potassium. In this case the reaction 2KOH+2H₂O+Ca(NO₃)₂→Ca(OH)₂+2KNO₃ will propagate. Application to hardened concrete pavements can be accomplished by spraying using equipment equivalent to that used to apply liquid de-icing salts. Application to horizontal or vertical surfaces can be accomplished by saturating porous materials, including but not limited to paper, cloth, or burlap, and placing them in direct contact with the concrete. This recognizes that means to limit the rate of evaporation, such as covering with plastic sheeting, should be employed.

Rather than employing a soft material, such as cloth, paper or burlap, the salts needed to interfere with ASR can be employed by incorporating them into a porous overlay. Such an overlay could be concrete, mortar, or asphaltic material.

Whereas particular embodiments of this invention have been described above for purposes of illustration, it will be evident to those skilled in the art that numerous variations of the details of the present invention may be made without departing from the invention as defined in the appended claims.

1. A method of reducing hydroxyl ions in concrete pore solutions containing alkali metal cations and hydroxyl ions, comprising adding a salt to concrete, wherein said salt comprises a cation, denoted herein as Cat, and an anion, denoted herein as An, said cation having a higher valence than said anion, said Cat-An salt having a solubility in water that is greater than Cat-OH, such that when said Cat-An salt precipitates as Cat-OH the resulting alkali metal-An salt formed remains in solution or has a solubility in the concrete pore solution greater than that of said Cat-An salt.

2. The method of claim 1, wherein the concrete is setting.

3. The method of claim 1, wherein the concrete is hardened.

4. The method of claim 3, wherein the cation is selected from the group consisting of Ca, Fe, Mg, Mn, Al, Cu, Zn, Sr, Ti and combinations thereof.

5. The method of claim 4, wherein the cation is Ca.

6. The method of claim 3, wherein the anion is selected from the group consisting of nitrate, nitrite, acetate, benzoate, butyrate, citrate, formate, fumarate, gluconate, glycerophosphate, isobutyrate, lactate, maleate, methylbutyrate, oxalate, propionate, quinate, salicylate, valerate, chromate, tungstate, ferrocyanide, permanganate, monocalcium phosphate monohydrate, hypophosphate, and combinations thereof.

7. The method of claim 6, wherein the anion is nitrate.

8. The method of claim 3, wherein the salt is introduced into hardened concrete by adding the salt to a concrete overlay.

9. The method of claim 8, wherein the salt is added to fresh concrete that forms the concrete overlay.

10. The method of claim 3, wherein the salt is added in an amount sufficient to bring an effective Na₂O equivalent to an amount which is less than an effective Na₂O equivalent of cement used in said concrete.

11. The method of claim 3, wherein the salt is added in an amount sufficient to bring an effective Na₂O equivalent to less than about 0.8 percent by weight of cement used in said concrete.

12. The method of claim 3, wherein the salt is added in an amount sufficient to bring an effective Na₂O equivalent to less than about 0.6 percent by weight of cement used in said concrete.

13. The method of claim 1, wherein ambient temperature exceeds 50 degrees Fahrenheit.

14. The method of claim 1, wherein ambient temperature exceeds 70 degrees Fahrenheit.

15. The method of claim 1, further comprising adding a retarding admixture to the concrete to reduce setting speed.

16. The method of claim 15, wherein the retarding admixture includes Ca lignosulfonate.

17. The method of claim 15, wherein the retarding admixture includes a sodium salt of a hydrocarboxylic acid or a calcium salt of a hydrocarboxylic acid.

18. The method of claim 1, wherein the salt is added in an amount that is independent of ambient temperature.

19. The method of claim 18, wherein the salt is added in an amount that depends substantially on alkali content of cement used in making the concrete.

20. The method of claim 18, wherein the salt is added in an amount that depends substantially on Na₂O equivalent in cement used in making the concrete.

21. The method of claim 1, wherein the salt is mixed with a Ca salt that is not an accelerator.

22. The method of claim 21, wherein the Ca salt includes Ca acetate or Ca hydroxide.

23. The method of claim 1, wherein the salt comprises Ca formate in a greater than about two percent solution.

24. The method of claim 1, wherein the salt comprises Ca nitrite in a greater than about four percent solution.

25. The method of claim 1, wherein the salt comprises Ca nitrite, and the concrete does not contain embedded steel.

26. The method of claim 1, wherein the salt continues to precipitate as Cat-OH after the concrete has reached its set point.

27. The method of claim 1, wherein the salt continues to precipitate as Cat-OH after one day.

28. The method of claim 1, wherein the salt continues to precipitate as Cat-OH after seven days.

29. The method of claim 1, wherein the salt continues to precipitate as Cat-OH after 28 days.

30. The method of claim 1, wherein the salt continues to precipitate as Cat-OH after one year.

31. The method of claim 1, wherein the salt is coated with a dissolving agent to delay release of the salt.

32. The method of claim 31, wherein the dissolving agent includes a polymer.

33. The method of claim 31, wherein the dissolving agent includes methylcellulose.

34. The method of claim 1, further comprising the addition of a reduced solubility double salt that includes calcium cations and monovalent anions to control alkali silica reaction.

35. The method of claim 34, wherein the double salt comprises Ca(NO₂)₂.Ca(OH)₂.xH₂O, where x comprises a whole number ranging from about 0 to about 4.

36. The method of claim 34, wherein the double salt includes calcium hydroxide or calcium nitrate.

37. The method of claim 1, wherein the salt comprises a mixture of about 40 to 60 percent nitrate ions and about 60 to 40 percent nitrite ions.

38. The method of claim 1, wherein quantity of salt added to the concrete is directly proportional to quantity of hydroxyl ions removed from the pore solution.

39. A method of reducing hydroxyl ions in concrete pore solutions, comprising adding a silicon-containing alkoxide to said concrete.

40. The method of claim 39, wherein said silicon-containing alkoxide has the formula (RO)ₙSiR′₍₄₋ₓ₎, where x ranges from 1 to 4, R is an alkyl, alkenyl or alkynl group of one or more carbons, straight or branched, and each R can be the same or different from each other R or R′.

41. The method of claim 39, wherein said silicon-containing alkoxide is tetramethyloxysilane.

42. The method of claim 39, wherein said silicon-containing alkoxide is tetraethyloxysilane.

43. The method of claim 39, wherein said silicon-containing alkoxide is partially hydrolyzed tetraethyloxysilane with a Si content greater than about 28 percent by weight.

44. The method of claim 39, wherein said silicon-containing alkoxide is added to fresh concrete.

45. The method of claim 44, wherein said silicon-containing alkoxide is added to said fresh concrete as a solid.

46. The method of claim 44, wherein said silicon-containing alkoxide is added to said fresh concrete as an aqueous solution.

47. The method of claim 39, wherein said silicon-containing alkoxide is introduced into hardened concrete.

48. The method of claim 39, wherein said silicon-containing alkoxide is added to fresh concrete for use as an overlay over existing concrete.

49. The method of claim 39, wherein said silicon-containing alkoxide is introduced into a hardened concrete overlay over existing concrete.

50. The method of claim 39, wherein said silicon-containing alkoxide is added in an amount sufficient to bring an effective Na₂O equivalent to an amount which is less than an effective Na₂O equivalent of cement used in said concrete.

51. The method of claim 39, wherein said silicon-containing alkoxide is added in an amount sufficient to bring an effective Na₂O equivalent to less than about 0.8 percent by weight of cement used in said concrete.

52. The method of claim 39, wherein silicon-containing alkoxide is added in an amount sufficient to bring an effective Na₂O equivalent to less than about 0.6 percent by weight of cement used in said concrete.
